(19) United States
(12) Patent Application Publication
(10) Pub. No.: US 2024/0360615 A1
(43) Pub. Date: Oct. 31, 2024

(54) LAUNDRY APPLIANCE DRYER SYSTEM WITH A MOLECULAR SIEVE CONNECTED TO AN EJECTOR

(71) Applicant: Whirlpool Corporation, Benton Harbor, MI (US)

(72) Inventor: Rodney Welch, Benton Harbor, MI (US)

(73) Assignee: Whirlpool Corporation, Benton Harbor, MI (US)

(21) Appl. No.: 18/139,096

(22) Filed: Apr. 25, 2023

(51) Int. Cl. D06F 58/24; B01D 53/22; B01D 53/26; B01F 25/312; D06F 25/00; D06F 58/04; D06F 58/26

(52) U.S. Cl. CPC D06F 58/24; B01D 53/228; B01D 53/268; B01F 25/31242; D06F 25/00; D06F 58/04; D06F 58/26; D06F 58/263; B01D 2053/221

(57) ABSTRACT

A laundry appliance including an appliance housing, a tub positioned inside the appliance housing, a drum rotatably supported within the tub, and a drying system that recirculates drying air through a molecular sieve. The molecular sieve has a porous membrane that is arranged along a drying air recirculation path. The laundry appliance also includes an ejector with an inlet, a venturi nozzle, an outlet, and a suction port that is arranged in fluid communication with the molecular sieve. The suction port of the ejector is configured to pull water vapor in the drying air recirculation path through the porous membrane of the molecular sieve when a motive fluid is passed through the ejector from the inlet, through the venturi nozzle, to the outlet such that the drying air exiting the molecular sieve is less humid than the drying air entering the molecular sieve.

### FIELD

The present disclosure relates to laundry appliances and, more particularly, to a dryer or a combination washer and dryer appliance that includes a molecular sieve and ejector in the drying air recirculation path.

### BACKGROUND

The statements in this section merely provide background information related to the present disclosure and may not constitute as prior art.

Dryers and combination washer and dryer appliances exist in the art. Vented dryers are designed to exhaust drying air to the exterior environment after it exits the dryer. As a result, vented dryers do not reclaim the energy of evaporation by condensing the water vapor in the drying air back to water. Thus, the open drying cycle in conventional vented dryers consumes significant energy, requires high-power circuits and plugs (e.g., 220 Volt wiring) or high BTU gas heaters, and that combined with the requirement for a vent to the exterior environment limits where the appliance can be installed. Current heat pump dryers eliminate venting and reduce energy use by reclaiming the energy of condensation. However, they require a high-powered compressor and often take considerable time to dry clothes.

Accordingly, it would be desirable to have a dryer or combination washer and dryer appliance with a drying air recirculation path that increases efficiency even beyond that of a heat pump dryer and that requires less time to dry clothes compared to a heat pump dryer. Likewise, it is desirable for a dryer or combination washer and dryer appliance to be able to run on conventional low voltage circuits (e.g., 110 Volt wiring). Additionally, it is desirable to eliminate the need for a vent to the exterior environment outside the home or building in which the laundry appliance is installed.

### SUMMARY

This section provides a general summary of the disclosure and is not a comprehensive disclosure of its full scope nor all of its features.

The present disclosure provides a dryer or combination washer and dryer appliance that overcomes the deficiencies of conventional vented dryers and heat pump dryers, which are described above, by using a molecular sieve and an ejector deployed in a novel way to separate water vapor from the drying air recirculation path. The highly concentrated water vapor drawn through the molecular sieve is compressed by the ejector and then passes through a heat exchanger that is arranged to heat the drying air and promote evaporation before the drying air re-enters the drum. Thus, the drying air that is fed back into the drum has a lower humidity and higher temperature compared to the drying air entering the molecular sieve. As such, the drying air that enters the drum can pick up more moisture from the laundry inside the drum and then recirculate through the drying air recirculation path.

According to one aspect of the present disclosure, a laundry appliance is provided with an appliance housing, a drum that is rotatably supported within the appliance housing, and a drying air recirculation path that is configured to circulate drying air through the drum. A laundry compartment is positioned inside the drum and the drying air inlet and the drying air outlet are arranged to circulate the drying air through the drum. The laundry appliance includes a molecular sieve that is positioned along the drying air recirculation path. The molecular sieve has one or more sieve membranes that are arranged along the drying air recirculation path and one or more negative pressure chambers that are configured to draw water vapor out of the drying air and through the sieve membranes such that the drying air exiting the molecular sieve is less humid than the drying air entering the molecular sieve. The laundry appliance also includes a closed loop motive water circuit. The closed loop motive water circuit has an ejector that includes a motive water inlet, a venturi nozzle, a motive water outlet, and a suction port that is arranged in fluid communication with the negative pressure chamber of the molecular sieve. The suction port of the ejector is configured to pull negative pressure on the negative pressure chamber(s) of the molecular sieve when motive water is passed through the ejector from the motive water inlet, through the venturi nozzle, to the motive water outlet, which pulls the water vapor out of the drying air and through the sieve membrane(s).

In accordance with another aspect of the present disclosure, the laundry appliance includes an appliance housing, a tub positioned inside the appliance housing, a drum rotatably supported within the tub, and a drying system that recirculates drying air through a molecular sieve. The molecular sieve has a porous membrane that is arranged along a drying air recirculation path. The laundry appliance also includes an ejector with an inlet, a venturi nozzle, an outlet, and a suction port that is arranged in fluid communication with the molecular sieve. The suction port of the ejector is configured to pull water vapor in the drying air recirculation path through the porous membrane of the molecular sieve when a motive fluid is passed through the ejector from the inlet, through the venturi nozzle, to the outlet such that the drying air exiting the molecular sieve is less humid than the drying air entering the molecular sieve.

In accordance with another aspect of the present disclosure, a method of drying laundry within a laundry appliance is provided. The method generally comprises the steps of rotating a drum within the laundry appliance to tumble the laundry located inside the drum and circulating drying air through the drum, through a drying air recirculation path, and through a molecular sieve, which is positioned along the drying air recirculation path. The method also includes the step of circulating motive water through a motive water circuit, which includes an ejector that has a suction port arranged in fluid communication with the molecular sieve. In accordance with this step, the flow of motive water through the ejector creates a negative pressure at the suction port of the ejector that pulls water vapor out of the drying air flowing past the molecular sieve and through the porous membrane such that the drying air exiting the molecular sieve is less humid than the drying air entering the molecular sieve.

Advantageously, the laundry appliances and associated operating method described herein consumes substantially less energy and is therefore more energy efficient than traditional vented dryers and heat pump dryers with comparable drying performance. The laundry appliances described herein also do not require a vent to the outside environment or a high voltage electrical outlet and therefore provide easier and more flexible installations. The laundry appliances described herein are also advantageous because they use water as a refrigerant and therefore do not require any refrigerants with ozone depletion potential or combustion potential. As a result, the laundry appliances described herein are safer, are more environmentally friendly, and can be disposed of and/or recycled more easily. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic diagram of an exemplary laundry appliance that has been constructed in accordance with the present disclosure where a heat exchanger is used to heat drying air flowing through a drying air recirculation path;

FIG. 2 is a schematic diagram of an exemplary ejector of the exemplary laundry appliance illustrated in FIG. 1;

FIG. 3 is a schematic diagram of another exemplary laundry appliance that has been constructed in accordance with the present disclosure where the laundry appliance includes a drum and heated water from a closed loop motive water circuit is circulated through the drum;

FIG. 4 is a front perspective view of an exemplary drum that can be used in the laundry appliance illustrated in FIG. 3; and

FIG. 5 is a perspective section view of the drum illustrated in FIG. 4.

### DETAILED DESCRIPTION

Referring to the Figures, wherein like numerals indicate corresponding parts throughout the several views, various aspects of a laundry appliance 10 are illustrated.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

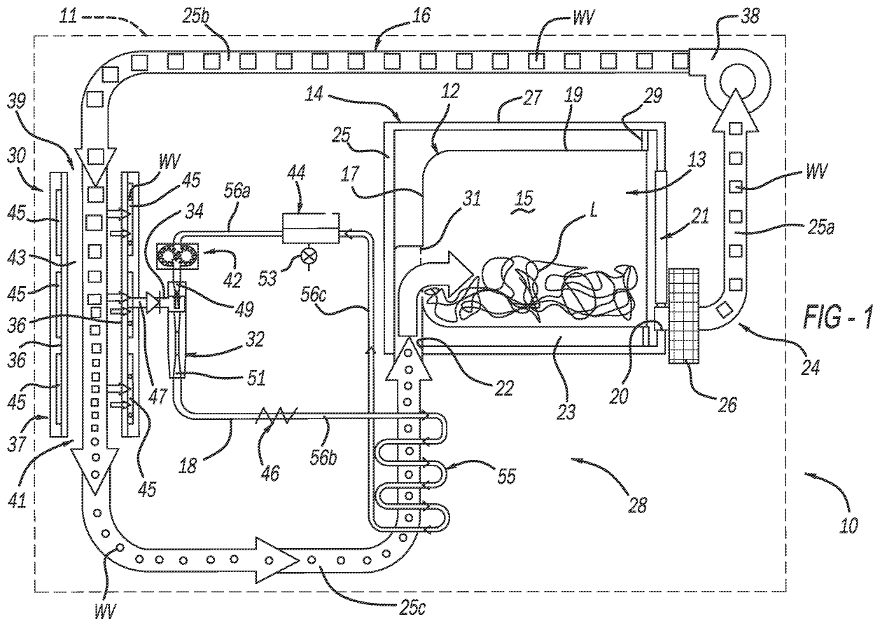

For purposes of description herein the terms “up,” “down,” “above,” “below,” “upper,” “lower,” “top,” “bottom,” “front,” “rear,” and derivatives thereof shall relate to the assembly as oriented in FIGS. 1-3. However, it is to be understood that the apparatus and assemblies described herein may assume various alternative orientations. Finally, the term “substantially” as used herein describes angles and/or orientations that can vary plus or minus five degrees from the referenced direction, axis, plane, or orientation.

FIG. 1 illustrates a laundry appliance 10 that includes an appliance housing 11 and a drum 12 rotatably supported within a tub 14 that is positioned within the appliance housing 11. The laundry appliance 10 may either be configured as a dryer (which is configured to run one or more drying cycles to dry laundry placed in the drum 12) or a combination washer and dryer appliance (which is configured to run both washing and drying cycles to wash and dryer laundry placed in the drum 12). The drum 12 includes a front drum opening 13 that provides access to a laundry compartment 15 inside the drum 12 for receiving laundry L, a rear drum wall 17, and a drum sidewall 19 that is generally cylindrical in shape and that extends longitudinally between the front drum opening 13 and the rear drum wall 17. The tub 14 includes a front tub opening 21 that provides access to an interior volume 23, a rear tub wall 25, and a tub sidewall 27 that extends between the front tub opening 21 and the rear tub wall 25. While not shown in FIG. 1, it should therefore be appreciated that the laundry appliance 10 includes one or more sets of controls, actuators, motors, valves, pumps, and other devices typical in a laundry appliance. It should further be appreciated that a motor (not shown) is coupled to and configured to drive rotation of the drum 12 within the tub 14 during drying and/or washing cycles. The present disclosure is primarily directed to the heating and drying of laundry L placed within the drum 12 during drying cycles and therefore focuses on the components of a novel drying system 28 for a laundry appliance 10.

As shown in FIG. 1, the drying system 28 of the laundry appliance 10 includes a drying air recirculation path 16 and a closed loop motive water circuit 18. The drying air recirculation path 16 includes a drying air inlet 20, a drying air outlet 22, and a duct system 24 connecting the drying air inlet 20 and the drying air outlet 22. Although other configurations are possible, in the illustrate example, the duct system 24 includes a first duct 25a, a second duct 25b, and a third duct 25c. The drying air inlet 20 and the drying air outlet 22 are coupled to and arranged in fluid communication with the tub 14 to enable the drying air to pass into the drum 12. The drying air inlet 20 and the drying air outlet 22 may be placed at various locations on the tub 14, but in the illustrated example, the drying air inlet 20 is located adjacent to the front tub opening 21 and the drying air outlet 22 is located in the rear tub wall 25. This helps promote the flow of drying air from the drying air outlet 22, through perforations 31 in the rear drum wall 17, through the laundry compartment 15 inside the drum 12, through the front drum opening 13, and to the drying air inlet 20. Optionally, a seal 29 may be provided between the drum sidewall 19 and the tub sidewall 27 to block drying air from traveling around the drum 12 instead of through it.

As the drying air flows through the interior volume 23 of the tub 14 and through the laundry compartment 15 of the drum 12, the drying air picks up moisture (i.e., water vapor) from the laundry inside the laundry compartment 15 and carries that moisture into the duct system 24 as water vapor WV. Thus, the humidity of the drying air entering the drying air inlet 20 is higher than the humidity of the drying air leaving the drying air outlet 22. Stated differently, the drying air flowing out of the interior volume 23 of the tub 14 through the drying air inlet 20 is more saturated with water vapor WV than the drying air flowing into the interior volume 23 of the tub 14 through the drying air outlet 22. Optionally, a lint filter 26 may be positioned at the drying air inlet 20 or elsewhere along the duct system 24 to filter out lint that may be released from the laundry within the laundry compartment 15 of the drum 12.

The laundry appliance 10 includes a molecular sieve 30 arranged along the drying air recirculation path 16, which functions to remove water vapor WV from the drying air recirculation path 16. The laundry appliance 10 further comprises an ejector 32 with a suction port 34 that is arranged in fluid communication with the molecular sieve 30 such that the water vapor WV that the molecular sieve 30 removes from the drying air recirculation path 16 is pulled into the suction port 34 of the ejector 32 and introduced into the closed loop motive water circuit 18. As a result, the drying air exiting the molecular sieve 30 is less humid (i.e., contains less moisture/water vapor WV) than the drying air entering the molecular sieve 30, which ultimately enables drying of the laundry L in the laundry compartment 15.

The molecular sieve 30 includes one or more sieve membranes 36, which are positioned within a housing 37. The molecular sieve 30 includes a sieve inlet 39 that is connected in fluid communication with and receives drying air from the duct system 24 and a sieve outlet 41 that is connected in fluid communication with a expels drying air back into the duct system 24. A drying air passageway 43 extends through the molecular sieve 30 from the sieve inlet 39 to the sieve outlet 41 therefore forms part of the drying air recirculation path 16. The sieve membranes 36 are positioned between and separate the drying air passageway 43 and at least one negative pressure chamber 45 of the molecular sieve 30. The sieve membranes 36 have molecular sieve properties and a large surface area. The sieve membranes 36 filter water vapor WV from the drying air flowing through the drying air passageway 43 in the molecular sieve 30. In particular, the sieve membranes 36 are porous. The size of the pores in the sieve membranes 36 are selected so as to permit smaller water molecules to pass through the sieve membranes 36 while blocking the passage of larger gas molecules present in the drying air. The negative pressure chambers 45 are therefore configured to collect the water vapor WV that passes through the sieve membranes 36 and are arranged in fluid communication with a sieve drain 47. The sieve drain 47 is then arranged in fluid communication with the suction port 34 of the ejector 32.

The molecular sieve 30 removes water vapor molecules from the drying air without changing the temperature and pressure of the drying air by creating a partial pressure differential for the water vapor WV across the sieve membranes 36. As such, the temperature of the drying air entering the sieve inlet 39 will be roughly the same as the temperature of the drying air exiting the sieve outlet 41. In other words, as the drying air passes through the drying air passageway 43 in the molecular sieve 30, the humidity ratio of the drying air may be reduced by 20% to 30% with only a slight drop in temperature. Thus, without the need to add significant heat, drier air enters the tub 14 through the drying air outlet 22 ready to accept more evaporated moisture from the laundry L in the laundry compartment 15 of the drum 12. As a non-limiting example, the drying air entering the sieve inlet 39 may have a relative humidity of 90% at 54 degrees Celsius (° C.). At these conditions, the partial pressure of the water vapor WV in the drying air is about 13.5 kilopascal (kPa). As an example, the negative pressure provided by the suction port 34 of the ejector 32 may lower the pressure of the water vapor WV the molecular sieve 30 extracts from the drying air to 6.5 kilopascal (kPa) in the negative pressure chambers 45 of the molecular sieve 30. This creates a partial pressure difference that draws water vapor molecules through the sieve membranes 36. Because pore size in the sieve membranes 36 cannot be controlled to perfection, some small amount of air, less than 0.1%, may be drawn through the sieve membranes 36 along with the water vapor molecules. In accordance with this example, the drying air that exits the molecular sieve 30 has a relative humidity of 66%, a temperature of 54 degrees Celsius (° C.), and a partial pressure of 9.9 kilopascal (kPa).

A blower 38 is positioned along the drying air recirculation path 16. The blower 38 operates to drive airflow through the drying air recirculation path 16. Although other configurations are possible, in the illustrated example, the first duct 25a extends from the drying air inlet 20 to the blower 38, the second duct 25b extends from the blower 38 to the sieve inlet 39, and the third duct 25c extends from the sieve outlet 41 to the drying air outlet 22. The speed of the blower 38 may be variable and can be adjusted by the machine controls that receive inputs from sensors placed at various locations along the drying air recirculation path 16 to vary the airflow traveling through the drying air recirculation path 16 in order to maintain a high relative humidity as drying rates diminish toward the end of the drying cycle. The sensors may measure relative humidity and/or temperature of the drying air entering the drying air inlet 20 and the drying air exiting the drying air outlet 22. This is necessary to get the maximum partial pressure of the water vapor in the drying air recirculation path 16, which is what drives the water vapor through the sieve membranes 36.

The ejector 32 is a venturi device with a motive water inlet 49 and a motive water outlet 51 that are connected to and arranged in fluid communication with the closed loop motive water circuit 18. The water vapor that enters the ejector 32 through the section port 34 mixes with the motive water and may be compressed to a pressure of 15.8 kilopascal (kPa) inside the ejector 32. The water vapor and motive water exits the motive water outlet 51 of the ejector 32 at a higher temperature than the motive water that enters the ejector 32 at the motive water outlet 49 by approximately 10 to 20 degrees Celsius (° C.). Further along the closed loop motive water circuit 18 the heated water vapor may pass through a heat exchanger 55 where excess heat from compression and condensation is transferred from the closed loop motive water circuit 18 to the drying air in the drying air recirculation path 16 before the drying air re-enters the tub 14 through the drying air outlet 22. Although other configurations are possible, in the illustrated example, the heat exchanger 55 is a water-to-air heat exchanger that is arranged along the third duct 25c such that the heat exchanger 55 heats the drying air passing through the third duct 25c just before the drying air enters the tub 14 through the drying air outlet 22.

Both the drying air recirculation path 16 and the closed loop motive water circuit 18 are positioned within the appliance housing 11 of the laundry appliance 10. The closed loop motive water circuit 18 further comprises a pump 42, a reservoir tank 44, and a heater 46. The water vapor WV that the ejector 32 pulls through the sieve membranes 36 condenses and mixes with the motive water in the closed loop motive water circuit 18. Thus, the volume of motive water in the reservoir tank 44 gradually increases during operation. Although other arrangements are possible, in the example illustrated in FIG. 1, the reservoir tank 44 is open to the atmosphere (atmospheric pressure). A drain 53 is therefore provided in the reservoir tank 44 that allows for removal/drainage of excess motive water that builds up in the closed loop motive water circuit 18. The drain 53 may be opened manually or automatically and may be configured to drain the excess motive water into the sump of the laundry appliance 10.

Although other configurations are possible, in the illustrated example, the closed loop motive water circuit 18 has a first conduit 56a that extends from the motive water outlet 51 of the ejector 32 to the heat exchanger 55, a second conduit 56b that extends from the heat exchanger 55 to the reservoir tank 44, and a third conduit 56c that extends from the reservoir tank 44 to the motive water inlet 49 of the ejector 32. The pump 42, which may have a gear pump configuration, is positioned along and connected in-line with the third conduit 56c and operates to pump motive water from the reservoir tank 44 to the motive water inlet 49 of the ejector 32.

The heater 46 is positioned along the first conduit 56a. The heater 46 may be an electric heater with electric heating elements that are positioned on or wound about the first conduit 56a or alternatively may be a gas heater with a burner assembly. The heater 46 is designed to be used during startup of a drying cycle to warm the motive water circulating through the closed loop motive water circuit 18 to an operating temperature of 55 degrees Celsius (° C.), which is needed to efficiently run the drying air recirculation path 16. For example, the laundry appliance 10 may run a wash cycle/wash program to wash the laundry L inside the laundry compartment 15 of the drum 12 prior to running a drying cycle. At the conclusion of the wash cycle and after the final spin, the wet laundry L, the drum 12, and the circulating drying air must be warmed to a desired temperature before effective drying can begin. Generally, the temperature of the drying air flow is raised to between 40 and 60 degrees Celsius (° C.). In the present example, the drying air is heated to approximately 55 degrees Celsius (° C.) by using the heater 46 to heat the motive water in the closed loop motive water circuit 18, which moves through the heat exchanger 55, heating the drying air in the third duct 25c. The heater 46 can then be turned off once the motive water in the closed loop motive water circuit 18 reaches a pre-determined threshold, such as 55 degrees Celsius (° C.). At this point, the heat of condensation reclaimed from the water vapor WP that the ejector 32 pulls in through the molecular sieve 30 heats the motive water in the closed loop motive water circuit 18, which passes through the heat exchanger 55, heating the drying air passing through the third duct 25c. In accordance with the exemplary numbers provided in the specification, this means that the drying air that enters the tub 14 through the drying air outlet 22 has a relative humidity of 29% and a temperature of 72 degrees Celsius (° C.). The heater 46 may also be used to provide supplemental heat as needed, even after a drying air temperature of approximately 55 degrees Celsius (° C.) is reached.

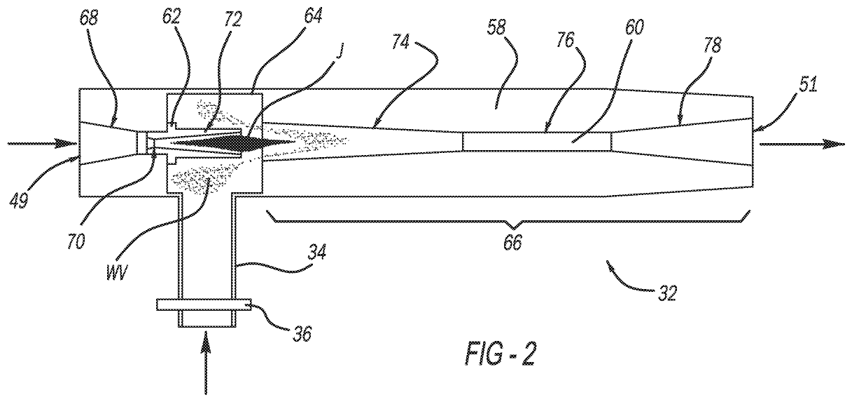

The ejector 32 is illustrated in greater detail in FIG. 2. The ejector 32 has an ejector body 58 with a motive water passageway 60 that extends longitudinally through the ejector body 58 between the motive water inlet 49 and the motive water outlet 51.

The motive water passageway 60 of the ejector 32 includes a venturi nozzle 62 downstream of the motive water inlet 49, a suction chamber 64 downstream of the venturi nozzle 62 that is arranged in fluid communication with the suction port 34, and a mixing section 66 downstream of the suction chamber 64 that ends at the motive water outlet 51. The venturi nozzle 62 includes a converging nozzle section 68 that gradually decreases in diameter moving from the motive water inlet 49 to a nozzle throat 70. Optionally, the venturi nozzle 62 may also include a diverging nozzle section 72 that protrudes into the suction chamber 64 and gradually increases in diameter moving from the nozzle throat 70 out towards the mixing section 66. The mixing section 66 is constructed as a second venturi. The mixing section 66 includes a converging mixing section 74 that decreases in diameter moving from the suction chamber 64 to a throat section 76 and a diverging mixing section 78 that gradually increases in diameter moving from the throat section 76 to the motive water outlet 51.

Although operating parameters may vary, in one example, the pump 42 supplies motive water to the motive water inlet 49 of the ejector 32 at a pressure of 620 to 790 kilopascal (kPa), a flow rate of 4.39 to 6 liters/min, and a temperature of 58 degrees Celsius (° C.). The motive water accelerates as it travels through the converging nozzle section 68 and nozzle throat 70. As the velocity of the motive water increases, the pressure drops below the vapor pressure of water at 18.7 kilopascal (kPa), which causes the motive water to flash to water vapor. This water vapor continues to accelerate as it travels through the diverging nozzle section 72, which causes the motive water vapor to cool to 52 degrees Celsius (° C.) and expand, reducing pressure of the motive water vapor to about 5 to 9.5 kilopascal (kPa). The flashed motive water vapor exits the diverging nozzle section 72 and enters the suction chamber 64 as a high speed jet of motive water vapor J, which creates negative pressure that draws in water vapor WV through the sieve membrane(s) 36, through the suction port 34 of the ejector 32, and into the suction chamber 64, where the extracted water vapor WV becomes entrained with the high speed jet of motive water vapor J. The extracted water vapor WV enters the suction port 34 at a pressure of 9.5 kPa, a flow rate of 0.120 kg/min, and a temperature of 58 degrees Celsius (° C.). The extracted water vapor WV mixes with the high speed jet of motive water vapor J in the mixing section 66 of the ejector 32. The high speed jet of motive water vapor J is cooler than the extracted water vapor WV and the extracted water vapor WV condenses inside the mixing section 66 of the ejector 32. The flow of motive water vapor and extracted water vapor is compressed such that pressure recovery is realized in the divergent mixing section and both the motive water and extracted water vapor turns to liquid at the motive water outlet 51 at a pressure of about 101 kilopascal (kPa), a flow rate of about 6.120 liters/min, and a temperature of 71 to 76 degrees Celsius (° C.). Thus, the ejector 32 reclaims the energy of condensation from the water vapor (steam) extracted by the molecular sieve 30 to heat the motive water in the closed loop motive water circuit 18, which is then circulated through the heat exchanger 55 and used to heat the drying air in the drying air recirculation path 16. At the point where the motive water in the closed loop motive water circuit 18 leaves the heat exchanger 55, the temperature of the motive water may be about 61 degrees Celsius (° C.). Based on the exemplary numbers provided in this specification, the approximate power consumption of the disclosed laundry appliance 10 is about 500 to 600 Watts (W). About half of this power consumption is attributed to running the pump 42 in the closed loop motive water circuit 18, with the rest being attributed to rotating the drum 12, running the heater 46, the blower 38, and other electronics. By comparison, a traditional vented dryer consumes about 5,400 Watts (W) and a traditional heat pump dryer consumes about 1,400 to 2,200 Watts (W) to achieve comparable drying performance/capacity. Thus, the disclosed laundry appliance 10 uses substantially less energy than conventional vented dryers and heat pump dryers.

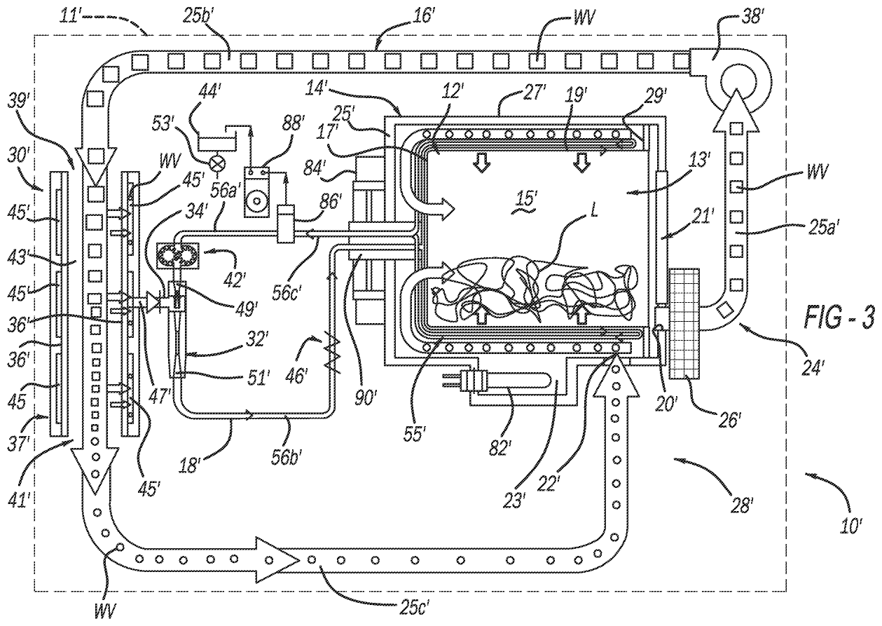

FIG. 3 illustrates another laundry appliance 10′ that shares many of the same components as the laundry appliance 10 illustrated in FIG. 1, but the heat exchanger 55 shown in FIG. 1 has been relocated and reconfigured in FIG. 3 such that the heat exchanger 55′ in FIG. 3 is positioned along the drum sidewall 19′. Rather than repeat the description set forth above, the following paragraphs describe the structure and function of the components in FIG. 3 that are new and/or different from those shown and described in connection with FIG. 1. It should be appreciated that the reference numbers in FIG. 3 have the prime symbol (′) added after the reference numbers (e.g., 10′, 11′, 12′, etc.), but otherwise share the same base reference numbers as the corresponding elements in FIG. 1. Thus, the same description for elements 10, 11, and 12 above applies to elements 10′, 11′, and 12′ in FIG. 3 and so on and so forth, except as otherwise noted.

In FIG. 3, the heat exchanger 55′ of the closed loop motive water circuit 18′ is positioned along the drum sidewall 19′ (i.e., the conduit(s)/loop(s) of the heat exchanger 55′ are positioned on or in the drum sidewall 19′). Instead of transferring the energy from the heated motive water in the closed loop motive water circuit 18′ to the drying air in the drying air recirculation path 16′, the heat exchanger 55′ transfers heat to the drum 12′ by conduction. The heat is then transferred to the laundry L in the laundry compartment 15′ of the drum 12′ through conduction (i.e., contact) and through convection (i.e., the heated drum 12′ also warms the drying air passing through the interior volume 23′ of the tub 14′ which then heats the laundry L and pulls moisture away from the laundry L through evaporation). During a drying cycle, the laundry L tumbles within the laundry compartment 15′ of the drum 12′ as the drum 12′ is rotatably driven by motor 84′. To enhance heat transfer through convention, the drum sidewall 19′ may optionally include a plurality of passages, slots, gaps, or holes 80′ between the conduit(s)/loop(s) of the heat exchanger 55′ through which heated drying air may flow into the laundry compartment 15′ of the drum 12′. In accordance with this arrangement, the drying air outlet 22′ of the drying air recirculation path 16′ may be positioned in the tub sidewall 27′ closer to the front tub opening 21′ and the seal 29′ prevents the drying air entering the interior volume 23′ of the tub 14′ through the during air outlet 22′ from bypassing the drum 12′ and flowing directly into the drying air inlet 20′ of the drying air recirculation path 16′.

In FIG. 3, the closed loop motive water circuit 18′ includes a heater 46′ for pre-heating the motive water in the closed loop motive water circuit 18′ during initial start-up of a drying cycle and/or to provide supplemental heat. Although the location of the heater 46′ may vary, in the illustrated example, the heater 46′ is located in the third conduit 56c′ between the ejector 32′ and the heat exchanger 55′ in/on the drum 12′. The laundry appliance 10′ may optionally include an alternate heater 82′ that is arranged in fluid communication with the interior volume 23′ of the tub 14′. The alternate heater 82′ may be an electric or gas heater and is configured to heat the drying air inside the tub 14′ during initial start-up of a drying cycle and/or to provide supplemental heat. For example, the alternate heater 82′ may run at the end of a drying cycle to reduce the length (e.g., number of minutes) of the drying cycle.

The closed loop motive water circuit 18′ shown in FIG. 3 also includes an air separator 86′ that is configured to remove any air that is introduced into the closed loop motive water circuit 18′, such as any small amounts of air drawn through the sieve membrane 36′ by the ejector 32′. The air separator 86′ is arranged in fluid communication with a vacuum pump 88′, which is then arranged in fluid communication with the reservoir tank 44′. The vacuum pump 88′ may be a diaphragm pump or another positive displacement pump and is configured to draw excess motive water that is added to the closed loop motive water circuit 18′ by condensation through the air separator 86′ and discharges it into the reservoir tank 44′. When the reservoir tank 44′ becomes full, it can be drained through drain 53′. Although other configurations are possible, in the illustrated example, the first conduit 56a′ of the closed loop motive water circuit 18′ extends between the air separator 86′ and the motive water inlet 39′ of the ejector 32′, the second conduit 56b′ of the closed loop motive water circuit 18′ extends between air separator 86′ and the heat exchanger 55′ in/on the drum 12′, and the third conduit 56c′ of the closed loop motive water circuit 18′ extends between the motive water outlet 51′ of the ejector 32′ and the heat exchanger 55′ in/on the drum 12′. A rotating fluid coupling 90′ is provided at the rear tub wall 25′ to communicate fluid between the heat exchanger 55′ in/on the drum 12′ the second and third conduits 56b′, 56c′ of the closed loop motive water circuit 18′. The rotating fluid coupling 90′ may be provided in the form of a rotating union hub coupling, which provides inlet and outlet passages for motive water into and out of the rotating drum 12′.

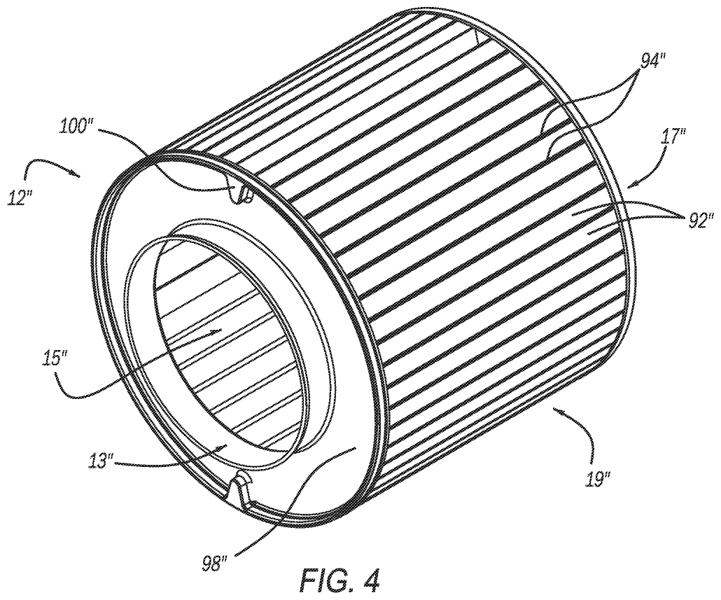

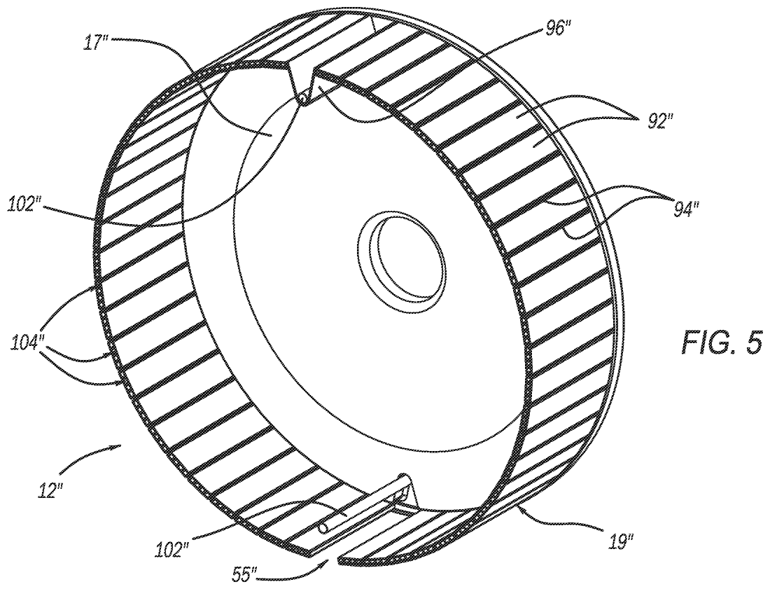

FIGS. 4 and 5 illustrate an alternative embodiment of the drum 12′ shown in FIG. 3. As such, the drum 12″ shown in FIGS. 4 and 5 may replace the drum 12′ of the laundry appliance 10′ shown in FIG. 3. Rather than repeat the description set forth above, the following paragraphs describe the structure and function of the components of the drum 12″ in FIGS. 4 and 5 that are new and/or different from those shown and described in connection with FIG. 3. It should be appreciated that the reference numbers in FIGS. 4 and 5 have a double prime symbol (″) added after the reference numbers (e.g., 12″, 13″, etc.), but otherwise share the same base reference numbers as the corresponding elements in FIG. 3. Thus, the same description for elements 12′ and 13′ above applies to elements 12″ and 13″ in FIGS. 4 and 5 and so on and so forth, except as otherwise noted.

The drum 12″ illustrated in FIGS. 4 and 5 includes a rear drum wall 17″ and a drum sidewall 19″. The drum sidewall 19″ is comprised of a plurality of tubular members 92″ that are circumferentially spaced from one another and are separated by gaps 94″. The gaps 94″ between the tubular members 92″ permit drying air within the tub 14′ to flow into the laundry compartment 15″ inside the drum 12″ and carry away evaporated water from the laundry L. The drum 12″ also includes lifters 96″ that are mounted to the drum sidewall 19″ and project into the laundry compartment 15″ to lift and turn over laundry L during rotation of the drum 12″ to promote tumbling inside the laundry compartment 15″.

Although other configurations are possible, the tubular members 92″, the gaps 94″ between the tubular members 92″, and the lifters 96″ may all extending longitudinally along the drum sidewall 19″ from the rear drum wall 17″ to a front ring 98″ of the drum 12″. The front ring 98″ or front bulkhead of the drum 12″ circumscribes the front drum opening 13″ and may include a front manifold 100″ that includes a ring-shaped channel and a pocket that is arranged in fluid communication with the ring-shaped channel and is aligned with one or more of the lifters 96″. As best seen in FIG. 5, the drum 12″ may additionally include a heat exchanger 55″ that is comprised of a series of heat exchanger conduits 102″ and channels 104″ that run along the drum sidewall 19″. The heat exchanger conduits 102″ of the heat exchanger 55″ extend from the rotating fluid coupling 90′, through or along the rear drum wall 17″, and inside the lifters 96″ to the manifold pockets 100″ in the front ring 98″ of the drum 12″. The heat exchanger conduits 102″ therefore circulate heated motive water from the rotating fluid coupling 90′ to the manifold pockets 100″ in the front ring 98″ where the heated motive water is then distributed among/fed to the channels 104″ in the tubular members 92″ and flows back towards the rear drum wall 17″. The motive water then exits the channels 104″ in the tubular members 92″ at the rear drum wall 17″ or rear bulkhead, collects in a ring-shaped rear manifold, and flows back to the rotating fluid coupling 90′ and the closed loop motive water circuit 18′. The flow of motive water through the heater exchanger 55″ of the drum 12″ therefore heats the tubular members 92″ and/or lifters 96″, which heats the laundry L through conduction and the drying air in the interior volume 23′ of the tub 14′ through convection.

As shown in FIG. 5, each tubular member 92″ may have an elongated shaped, rectangular cross-section, and may include multiple channels 104″ that are positioned in a parallel side-by-side arrangement. Thus, the tubular members 92″ may be extruded with a series of micro-channels 104″ (i.e., micro-channel extrusions). The tubular members 92″ and/or the entire drum 12″ may be powder coated to seal the channels 104″ where they meet the rear drum wall 17″ and the front ring 98″.

In accordance with this embodiment, the laundry L comes into direct contact with the tubular members 92″ during tumbling so that some heat passes directly by conduction from the heated motive water in the channels 104″, through the walls of the tubular members 92″, and into the laundry L to promote the evaporation of water saturated in the laundry L. The drying air in the interior volume 23′ of the tub 14′ flows around the outside of the drum between the drum 12″ and picks up some heat from the tubular members 92″ as it passes through the gaps 94″ in the drum sidewall 19″. This forces the drying air very close to the interface (i.e., points of contact) between the laundry L and the tubular members 92″, which is where much of the evaporation will take place inside the drum 12″. If a constant flow of drying air were not supplied to this interface between the laundry 12″ and the drum 12″, the localized air would become saturated and stop evaporation. The drum 12″ is therefore specifically designed to introduce and replenish drying air close to this interface so that it will carry the evaporated water away from the points of contact between the laundry L and the drum 12″. This lowers the relative humidity of the drying air in the laundry compartment 15″ so there can be more evaporation. Testing has indicated that the rate of evaporation is more than doubled when air flow is provided through the drum sidewall 19″. The tumbling of the laundry L within the drum 12″ will also continue to expose different areas/surfaces of the laundry L to the hot tubular members 92″ of the drum 12″.

After the motive water passes through the tubular members 92″, it is collected in the rear drum wall 17″ and passed through the rotating fluid coupling 90′ to complete the circuit back through the pump 42′ and the ejector 32′. The ejector 32′ operates to raise the temperature of the motive water in the closed loop motive water circuit 18′ to a temperature that is about 10 to 20 degree Celsius (° C.) above the temperature of the drying air. If the pump 42′ is driven to provide a motive water flow rate of approximately 5.6 liters per minute (1/min), the heat capacity of the motive water allows it to carry about 3,760 Watts (W) of drying capacity to the drum 12″. The vacuum pump 88′ removes the increasing amount of motive water that collects in the closed loop motive water circuit 18′ as the water vapor WV (i.e., steam) condenses and mixes with the circulating water in the closed loop motive water circuit 18′ and also functions to keep the pressure in the closed loop motive water circuit 18′ below atmospheric pressure to help the ejector 32′ so that it does not have to “lift” all the way back up to atmospheric pressure. In other words, after passing through the ejector 32′, the motive water and extracted water vapor is in a liquid vacuum in both the closed loop motive water circuit 18′ and the heat exchanger 55″ until it returns to the pump 42′ where the motive water is pressurized again to go through the ejector 32′. By lowering the pressure inside the closed loop motive water circuit 18′ to a pressure below atmospheric pressure, the vacuum pump 88′ allows more water vapor entrainment in the ejector 32′. The power requirements of the pump 42′ and the vacuum pump 88′ are relatively low. For example, the power consumption of the pump 42′ may be about 125 Watts (W) and the power consumption of the vacuum pump 88′ may be about 10 Watts (W) for a total power consumption of about 135 Watts (W).

A method of drying laundry within the laundry appliances 10, 10′ discussed above will now be described. The method generally comprises the steps of rotating the drum 12, 12′, 12″ within the laundry appliance 10, 10′ to tumble the laundry L located inside the drum 12, 12′, 12″ and circulating the drying air through the drum 12, 12′, 12″, through the drying air recirculation path 16, 16′, and through the molecular sieve 30, 30′, which is positioned along the drying air recirculation path 16, 16′. The method also includes the step of circulating the motive water through the motive water circuit 18, 18′, which includes the ejector 32, 32′ described above. In accordance with this step, the flow of motive water through the ejector 32, 32′ creates a negative pressure at the suction port 34, 34′ of the ejector 32, 32′ that pulls water vapor out of the drying air flowing past the molecular sieve 30, 30′ and through the sieve membrane 36, 36′ (i.e., the porous membrane) such that the drying air exiting the molecular sieve 30, 30′ is less humid than the drying air entering the molecular sieve 30, 30′. The method may also include the steps of: introducing the water vapor that the suction port 34, 34′ of the ejector 32, 32′ pulls through the porous membrane 36, 36′ of the molecular sieve 30, 30′ into the motive water flowing through the ejector 32, 32′ such that the water vapor pulled through the porous membrane 36, 36′ condenses and adds heat to the motive water exiting the ejector 32, 32′ and circulating the heated motive water exiting the ejector 32, 32′ through the heat exchanger 55, 55′, 55″. As explained above, the heat exchanger 55, 55′, 55″ may either transfer heat from the motive water to the drying air in the drying air recirculation path 16 or to the drum 12′, 12″.

The foregoing description of the embodiments has been provided for purposes of illustration and description in the context of a combination washer/dryer. It is not intended to be exhaustive or to limit the disclosure from use in other embodiments such as a standalone dryer. Individual elements or features of a particular embodiment are generally not limited to that particular embodiment, but, where applicable, are interchangeable and can be used in a selected embodiment, even if not specifically shown or described. The same may also be varied in many ways. Such variations are not

What is claimed is:

1. A laundry appliance, comprising:
an appliance housing:
a drum that is rotatably supported within the appliance housing and includes a laundry compartment inside the drum;
a drying air recirculation path configured to circulate drying air, the drying air recirculation path extending between a drying air inlet and a drying air outlet that are arranged to circulate the drying air through the drum;
a molecular sieve positioned along the drying air recirculation path, the molecular sieve including at least one sieve membrane that is arranged along the drying air recirculation path and at least one negative pressure chamber that is configured to draw water vapor out of the drying air and through the sieve membrane such that the drying air exiting the molecular sieve is less humid than the drying air entering the molecular sieve; and
a closed loop motive water circuit including an ejector that includes a motive water inlet, a venturi nozzle, a motive water outlet, and a suction port arranged in fluid communication with the negative pressure chamber of the molecular sieve that is configured to pull negative pressure on the negative pressure chamber of the molecular sieve when motive water is passed through the ejector from the motive water inlet, through the venturi nozzle, to the motive water outlet.

2. The laundry appliance according to claim 1, wherein the ejector includes a mixing chamber positioned between the venturi nozzle and the motive water outlet where the water vapor pulled through the sieve membrane mixes with the motive water in the closed loop motive water circuit and condenses, adding heat to the motive water exiting the motive water outlet.

3. The laundry appliance according to claim 2, further comprising:
a heat exchanger arranged in fluid communication with the closed loop motive water circuit downstream of the motive water outlet of the ejector, wherein the heat exchanger is configured to transfer heat from the motive water exiting the motive water outlet to at least one of the drying air in the drying air recirculation path or the drum.

4. The laundry appliance according to claim 3, further comprising:
a pump that is positioned along and connected in fluid communication with the closed loop motive water circuit to pump the motive water through the closed loop motive water circuit and heat exchanger.

5. The laundry appliance according to claim 4, further comprising:
a reservoir tank positioned along and arranged in fluid communication with the closed loop motive water circuit between the heat exchanger and the pump and wherein the ejector is positioned along the closed loop motive water circuit between the pump and the heat exchanger.

6. The laundry appliance according to claim 3, further comprising:
a heater arranged along the closed loop motive water circuit and configured to heat the motive water in the closed loop motive water circuit at the beginning of a drying cycle or to supply supplemental heat.

7. The laundry appliance according to claim 6, wherein the heating is an electric heater or a gas heater and is positioned along the closed loop motive water circuit between the ejector and the heat exchanger.

8. The laundry appliance according to claim 3, wherein the heat exchanger is positioned along the drying air recirculation path upstream of the drying air outlet to transfer heat from the motive water exiting the motive water outlet of the ejector to the drying air in the drying air recirculation path before the drying air exits the drying air outlet and enters the drum.

9. The laundry appliance according to claim 3, wherein the drum has a rear drum wall and a drum sidewall and wherein the heat exchanger is positioned in or on the drum sidewall such that heat from the motive water flowing through the heat exchanger heats the drum and is conducted through the drum sidewall to laundry placed in the laundry compartment of the drum.

10. The laundry appliance according to claim 1, further comprising:
a blower arranged in fluid communication with the drying air recirculation path and configured to circulating the drying air through the drying air recirculation path.

11. The laundry appliance according to claim 1, wherein the sieve membrane has a pore size that is configured to permit water molecules in the drying air to pass through the sieve membrane and collect in the negative pressure chamber of the molecular sieve and block larger gas molecules present in the drying air.

12. The laundry appliance according to claim 1, further comprising:
a tub at least partially enclosing the drum such that the drum is rotatable within the tub, wherein the drying air outlet and the drying air inlet are positioned to communicate the drying air into and out the tub.

13. The laundry appliance according to claim 1, wherein the laundry appliance is a combination washer and dryer appliance.

14. The laundry appliance according to claim 1, wherein the laundry appliance is a ventless dryer.

15. A laundry appliance, comprising:
an appliance housing;
a tub positioned inside the appliance housing;
a drum rotatably supported within the tub;
a drying system that recirculates drying air through a molecular sieve, the molecular sieve having a porous membrane that is arranged along a drying air recirculation path; and
an ejector with an inlet, a venturi nozzle, an outlet, and a suction port that is arranged in fluid communication with the molecular sieve and configured to pull water vapor in the drying air recirculation path through the porous membrane of the molecular sieve when a motive fluid is passed through the ejector from the inlet, through the venturi nozzle, to the outlet such that the drying air exiting the molecular sieve is less humid than the drying air entering the molecular sieve.

16. The laundry appliance according to claim 15, wherein the water vapor that is drawn through the porous membrane of the molecular sieve condenses and mixes with the motive fluid inside the ejector and adds heats to the motive fluid through the heat of condensation.

17. The laundry appliance according to claim 15, further comprising:
a heat exchanger arranged in fluid communication with the outlet of the ejector, wherein the heat exchanger is configured to transfer heat from the motive fluid exiting the outlet of the ejector to at least one of the drying air in the drying air recirculation path or the drum.

18. The laundry appliance according to claim 15, wherein the porous membrane of the molecular sieve has a pore size that is configured to permit water molecules in the drying air to pass through the porous membrane and block larger gas molecules present in the drying air.

19. A method of drying laundry within a laundry appliance, the method comprising the steps of:
rotating a drum within the laundry appliance to tumble laundry located inside the drum;
circulating drying air through the drum, through a drying air recirculation path, and through a molecular sieve that is positioned along the drying air recirculation path; and
circulating motive water through a motive water circuit that includes an ejector with a suction port that is arranged in fluid communication with the molecular sieve such that the flow of motive water through the ejector creates a negative pressure at the suction port that pulls water vapor out of the drying air flowing past the molecular sieve and through a porous membrane in the molecular sieve such that the drying air exiting the molecular sieve is less humid than the drying air entering the molecular sieve.

20. The method according to claim 19, further comprising the steps of:
introducing the water vapor that the suction port of the ejector pulls through the porous membrane of the molecular sieve into the motive water flowing through the ejector such that the water vapor pulled through the porous membrane condenses and adds heat to the motive water exiting the ejector; and
circulating the heated motive water exiting the ejector through a heat exchanger, wherein the heat exchanger transfers heat from the motive water to at least one of the drying air in the drying air recirculation path and the drum.
